(19) United States
(12) Patent Application Publication
(10) Pub. No.: US 2007/0154721 A1
(43) Pub. Date: Jul. 5, 2007

(54) Heat transfer fluids with heteroatom-containing carbon nanocapsules

(75) Inventors: Wu-Jing Wang, Hsinchu City (TW); Che-Yu Tsai, Miaoli County (TW); Joung-Yei Chen, Taipei County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/442,117

(22) Filed: May 30, 2006

(30) Foreign Application Priority Data
Dec. 30, 2005 (TW) 94147871

(51) Int. Cl. B32B 27/00; B05D 5/06; F21V 9/04; G02B 5/22

(52) U.S. Cl. 428/413; 428/500; 252/587; 427/162

(57) ABSTRACT

An infrared cut-off hard coating. The infrared cut-off hard coating comprises the product through the following steps. A coating of a composition is formed, wherein the composition comprising the following components as a uniform solution in an organic solvent: a multi-functionality polymerizable resin, infrared cut-off particles, and a free radical initiator. The coating is cured to form the infrared cut-off hard coating with a thickness of not less than 1000 nm. Due to the sufficient thickness thereof, the infrared cut-off hard coating has improved supportability and surface hardness.

### BACKGROUND OF THE INVENTION

1. Field of the Invention

The invention relates to an infrared cut-off coating, and in particular to an infrared cut-off hard coating and method for fabricating the same.

2. Description of the Related Art

In general, infrared cut-off coatings have been used for controlling the thermal effects of solar radiation. For example, infrared cut-off coatings are adhered to windowpanes of buildings, automobiles, and the like so as to reduce heat from direct sunlight being transmitted therethrough.

With the development of flat panel display technology, optical films, employed in the flat panel display, with various functionalities are desirable. For domestic flat panel televisions, the infrared radiation generated thereby not only endangers health of users, but interferes with televisions infrared remote controls. Moreover, in order to improve the contrast and visibility of liquid crystal devices (LCDs) under sunlight, the power of the backlight source must be intensified for high brightness, resulting in the heat accumulation. To prevent excess generation heat generation in LCDs produced by the infrared radiation of sunlight. Accordingly, an infrared cut-off coating suitable for use in LCDs for preventing the described problems is called for.

Murata Tsutomu (JP-2001-343519) proposes an infrared cut-off coating composition, comprising infrared cut-off particles and photosensitive resin. When the infrared cut-off coating composition is exposed to an actinic ray or radiation, the photosensitive resin is polymerized, thereby wrapping the infrared cut-off particles therein. Since the infrared cut-off particles' are a nanoscale inorganic compound, the photosensitive resin polymers are not apt to mix with the infrared cut-off particles. In order to solve the aforementioned problems, Murata teaches that the infrared cut-off coating composition is further subjected to a ball mill treatment to obtain an optical coating composition with improved uniformity. The infrared cut-off coating composition, however, is polymerized by cation series photo-initiator. Due to the low reaction rate of cation polymerization, the infrared cut-off particles are apt to be isolated from the photosensitive resin polymers, resulting in a particle mass of obtained infrared cut-off coating.

Furthermore, Murata also proposes the weight ratio between the infrared cut-off particles and the photosensitive resin is 60:40˜, preferably 80:20˜70:30, in order to increase the infrared cut-off capability. The transmittance of the obtained infrared cut-off coating, however, is substantially reduced due to the high weight ratio of the infrared cut-off particles. Accordingly, the conventional infrared cut-off coating is colored and has a thickness of less than 250 nm. Since the infrared cut-off coating has reduced mechanical strength due its low thickness, a hard coating layer is further formed on the nfrared cut-off coating for scratch resistance.

In general, an antireflection film or anti-glare film can be disposed on an outermost surface of an image display device such as an optical lens, a cathode ray tube display device (CRT), a plasma display panel (PDP), a liquid crystal display device (LCD), or an organic electroluminescent device, to reduce reflectance and glare so as to prevent optical interference caused by external light. Ito Masahiko (JP 2001-337203) proposes a multifunctional optical film 10, referring to FIG. 1, comprising a transparent substrate 12, a hard coating layer 14, an antireflection layer 24, a stain proof layer 22, and an adhesive layer 26, wherein the antireflection layer 24 comprises low refractive index layer 20, high refractive index layer 18, and middle refractive index layer 16. In the conventional multifunctional optical film, an infrared cut-off coating is formed between the hard coating layer 14 and the adhesive layer 26. The hard coating layer, antireflection layer, and infrared cut-off coating, however, are fabricated respectively by different processes, providing low yield, complex fabrication process, and high cost.

### BRIEF SUMMARY OF THE INVENTION

The invention provides an infrared cut-off hard coating, comprising the product through the following steps. A coating of a composition is formed, wherein the composition comprises the following components as a uniform solution in an organic solvent: a multi-functionality polymerizable resin, infrared cut-off particles, and a free radical initiator. The coating is cured to form the infrared cut-off hard coating with a thickness of not less than 1000 nm. Due to the sufficient thickness thereof, the infrared cut-off hard coating has improved supportability and surface hardness. It should be noted that the weight ratio between the particles and resin must be 10:90 to 55:45, preferably 30:70 to 50:50. Therefore, the infrared cut-off hard coating exhibits high transmittance even though the thickness is more than 1000 nm. JP 2001-343519 proposes that the infrared absorption is reduced with a low amount of infrared cut-off particles. In the invention, since the thickness of the infrared cut-off hard coating is more than four times greater than that of the conventional infrared cut-off coating, the total amount of infrared cut-off particles is greater than that of the conventional infrared cut-off coating. Therefore, the infrared cut-off capability of the coating of the invention is improved.

As a main feature and a key aspect, of the invention, the use of free radical initiator is substituted for the cation initiator used in convention infrared cut-off coating composition. Moreover, the polymerizable resin, the infrared cut-off particles, and the free radical initiator are dissolved and dispersed in the organic solvent, rather than simply mixing the infrared cut-off particles with the resin. Thus, the infrared cut-off particles are uniformly dispersed throughout the coating due to the superior reaction rate of free radical polymerization, before phase separation occurs. Conversely, the conventional infrared cut-off coating composition is polymerized by cation initiator. Due to the low reaction rate of cation polymerization, the phase separation period is extended and the infrared cut-off particles are aggregated resulting in opaque spots among the infrared cut-off coating.

An exemplary embodiment of forming an infrared cut-off hard coating comprises the following steps. A coating of a composition is formed, wherein the composition comprising the following components as a uniform solution in an organic solvent: a multi-functionality polymerizable resin, infrared cut-off particles, anti-glare particles and a free radical initiator. The coating is cured to form the infrared cut-off hard coating with a thickness of not less than 1000 nm. Wherein the weight ratio between the particles and resin is 10:90 to 55:45, and the weight ratio between the anti-glare particles and the resin is 1:99 to 35:65, preferably 5:95 to 15:85. The diameter of the anti-glare particle is between 100 nm to 5000 nm and can be organic polymeric particles (such as polystyrene, or polymethyl methacrylate)) or inorganic particles (such as silicon oxide).

Methods for fabricating the infrared cut-off hard coating are also provided. An exemplary embodiment of a method comprises the following steps: providing a composition comprising multi-functionality polymerizable resin, infrared cut-off particles, and a radical initiator, as a uniform solution in an organic solvent, wherein the weight ratio between the particles and resin is 10:90 to 55:45; forming a coating of the composition; and curing the coating to form the infrared cut-off hard coating with a thickness of not less than

In the invention, a layered composite film is also provided, comprising a transparent substrate, with a first surface and a second surface on the opposite side of the first surface, and the described infrared cut-off hard coating formed on the first surface of the substrate.

According to the invention, the thickness of the infrared cut-off hard coating is modified for reducing reflectivity. Namely, the infrared cut-off hard coating of the invention can work on the principle of destructive interference by adjusting the product of the film thickness and the refractive index to be one quarter or a higher odd multiple of the incident light wavelength.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross section of a conventional multifunctional optical film employed in a flat panel display;

FIG. 2 is a cross section of an infrared cut-off layered composite film according to the third example of the invention;

FIG. 3 is a cross section of an infrared cut-off layered composite film according to the fourth example of the invention; and

FIG. 4 is a cross section of an infrared cut-off layered composite film according to the fifth example of the invention;

FIG. 5 is a cross section of an infrared cut-off layered composite film according to the sixth example of the invention;

FIG. 6 is a cross section of an infrared cut-off layered composite film according to the seventh example of the invention; and

FIG. 7 is a cross section of an infrared cut-off layered composite film according to the eighth example of the invention.

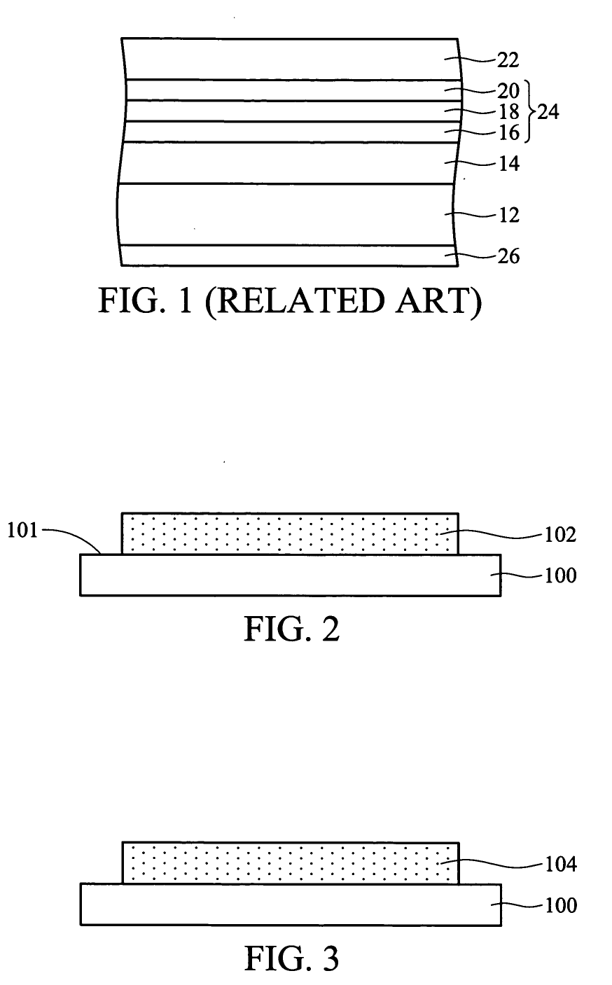

### DETAILED DESCRIPTION OF THE INVENTION

The invention provides an infrared cut-off hard coating exhibiting high scratch resistance, antireflectivity, and infrared cut-off capability, suitable for flat panel displays.

The method for fabricating the infrared cut-off hard coating comprises providing a composition comprising multi-functionality polymerizable resin, infrared cut-off particles, and a radical initiator, as a uniform solution in an organic solvent, wherein the weight ratio between the particles and resin is 10:90 to 55:45. The radical initiator is in an amount of 0.1 to 10 parts by weight, based on 100 parts by weight of the composition.

The multi-functionality polymerizable resin has a reactive functionality of more than 2.0, and comprises acrylic resin with multi-functionality or epoxy resin with multi-functionality. The infrared cut-off particles comprise ITO particles, IZO particles, AZO particles, ZnO particles, or combinations thereof. The initiator can be a photo-initiator or a thermal initiator, such as peroxide or azo initiator, which generates, upon activation, free radical species through decomposition, and can be 2,2′-azobis(2-cyano-2-butane), dimethyl 2,2′-azobis(methyl isobutyrate), 4,4′-azobis(4-cyanopentanoic acid), 4,4′-azobis(4-cyanopentan-1-ol), 1,1′-azobis(cyclohexane carbonitrile), 2-(t-butylazo)-2-cyanopropane, 2,2′-azobis[2-methyl-(N)-(1,1)-bis(hydroxymethyl)-2-hydroxyethyl]propionamide, 2,2′-azobis[2-methyl- N-hydroxyethyl)]propionamide, 2,2′-azobis(N,N′-dimethyleneisobutyramidine) dihydrochloride, 2,2′-azobis(2-amidinopropane) dihydrochloride, 2,2′-azobis (N,N′-dimethyleneisobutyramine), 2,2′-azobis(2-methyl-N-[1,1-bis(hydroxymethyl)-2-hydroxyethyl]propionamide, 2,2′-azobis(2-methyl-N-[ 1,1-bis(hydroxymethyl)ethyl]propionamide), 2,2′-azobis[2-methyl-N-(2-hydroxyethyl) propionamide], 2,2′-azobis(isobutyramide)dihydrate, 2,2′-azobis(2,2,4-trimethylpentane), 2,2′-azobis (2-methylpropane), dilauroyl peroxide, tertiary amyl peroxides, tertiary amyl peroxydicarbonates, t-butyl peroxyacetate, t-butyl peroxybenzoate, t-butyl peroxyoctoate, t-butyl peroxyneodecanoate, t-butylperoxy isobutyrate; t-amyl peroxypivalate, t-butyl peroxypivalate, di-isopropyl peroxydicarbonate, dicyclohexyl peroxydicarbonate, dicumyl peroxide, dibenzoyl peroxide, potassium peroxydisulfate, ammonium peroxydisulfate, di-tert butyl peroxide, di-t-butyl hyponitrite, dicumyl hyponitrite or combinations thereof. The template comprises non-reactive organic compound, non-reactive oligomer, non-reactive polymer, or combinations thereof. An exemplary embodiment of an infrared cut-off composition further comprises anti-glare particles, resulting in that the obtained hard coating has anti-glare characteristics. The diameter of the anti-glare particle is between 100 nm to 5000 nm and can be organic polymeric particles (such as polystyrene, or polymethyl methacrylate)) or inorganic particles (such as silicon oxide). Specifically, the weight ratio between the particles and resin is 10:90 to 55:45, and the weight ratio between the anti-glare particles and the resin is 1:99 to 35:65, preferably 5:95 to 15:85. The organic solvent must dissolve the polymerizable resin and template simultaneously. The organic solvent can comprise tetrahydrofuran, acetone, methyl-ethyl ketone, methyl-isobutyl ketone, benzene, toluene, or combinations thereof.

Next, a coating of the composition is formed on a substrate. The substrate can be a transparent substrate such as glass or plastic. The composition can be coated by spin coating, dip coating, roll coating, printing, embossing, stamping, or spray coating.

Next, the coating is cured to form an infrared cut-off hard coating with a thickness of not less than 1000 nm. In this step, the coating can be cured by exposure to uniform ultraviolet with a wavelength of more than 193 nm.

The invention also provides a layered composite film, comprising a transparent substrate, with a first surface and a second surface on the opposite side of the first surface. The infrared cut-off hard coating of the invention is formed on the first surface of the substrate. The layered composite film further comprises an anti-glare film formed on the infrared cut-off hard coating or the second- surface: An antireflective layer, having, a refractive index of 1.2˜1.48, can also be formed on the infrared cut-off hard coating or the second surface.

The following examples are intended to demonstrate this invention more fully without limiting its scope, since numerous modifications and variations will be apparent to those skilled in the art.

### Preparation of Infrared Cut-off Composition

### FIRST EXAMPLE

4.5 g ITO (Indium Tin Oxide) nano-particles (sold and manufactured under the trade number of SN-100P by ISHIHARA TECHNO Co., Ltd) was put into a bottle and dissolved in 21 g ethyl acetate. Then, 4.5 g pentaerythritol triacrylate as a polymerizable resin and 0.225 g 2,2′-azobis(2-cyano-2-butane) as a free radical initiator, were added into the bottle. Herein, the weight ratio between the particles and resin was 50:50. After sufficient stirring, an infrared cut-off composition (A) was prepared.

### SECOND EXAMPLE

3.8 g ITO (Indium Tin Oxide) nano-particles (sold and manufactured under the trade number of SN-100P by ISHIHARA TECHNO Co., Ltd) was put into a bottle and dissolved in 18.2 g ethyl acetate. Then, 3.8 g pentaerythritol triacrylate as a polymerizable resin, 0.19 g 2,2′-azobis(2-cyano-2-butane) as a free radical initiator, and 0.2 g polystyrene as anti-glare particles were added into the bottle. Herein, the weight ratio between the infrared cut-off particles and resin was 50:50, and the weight ratio between the anti-glare particles and resin was 5:95. After sufficient stirring, an infrared cut-off composition (B) was prepared.

### Preparation of Infrared Cut-off Layered Composite Film

### THIRD EXAMPLE

The infrared cut-off composition (A) was coated on a first surface 101 of a PET substrate 100 by spin coating at a speed of 500 rpm for 30 sec. Next, the substrate 100 was baked at 60° C. for 3 min to remove the solvent. Next, the substrate 100 was exposed to a UV ray, and an infrared cut-off hard coating 102, with a thickness of 5000 nm, was formed by free radical polymerization of the infrared cut-off composition (A), referring to FIG. 2.

Afterward, the transmittance of the layered composite film was measured at a measured wavelength between 400˜1900 nm. The layered composite film had a transmittance of 82.55% at a measured wavelength of 550 nm and a transmittance of 14.27% at a measured wavelength of 1900 nm. The layered composite film had an infrared absorptivity of 85.73% at a measured wavelength of 1900 nm.

### FOURTH EXAMPLE

The infrared cut-off composition (B) was coated on a first surface 101 of a PET substrate 100 by spin coating at a speed of 500 rpm for 30 sec. Next, the substrate 100 was baked at 60° C. for 3 min to remove the solvent. Next, the substrate 100 was exposed to a UV ray, and an infrared cut-off hard coating 104, with a thickness of 5000 nm, was formed by free radical polymerization of the infrared cut-off composition (A), referring to FIG. 3.

Afterward, the transmittance of the layered composite film was measured at a measured wavelength between 400˜1900 nm. The layered composite film had a transmittance of 81.80% at a measured wavelength of 550 nm and a transmittance of 11.93% at a measured wavelength of 1900 nm. The layered composite film had an infrared absorptivity of 88.07% at a measured wavelength of 1900 nm.

### FIFTH EXAMPLE

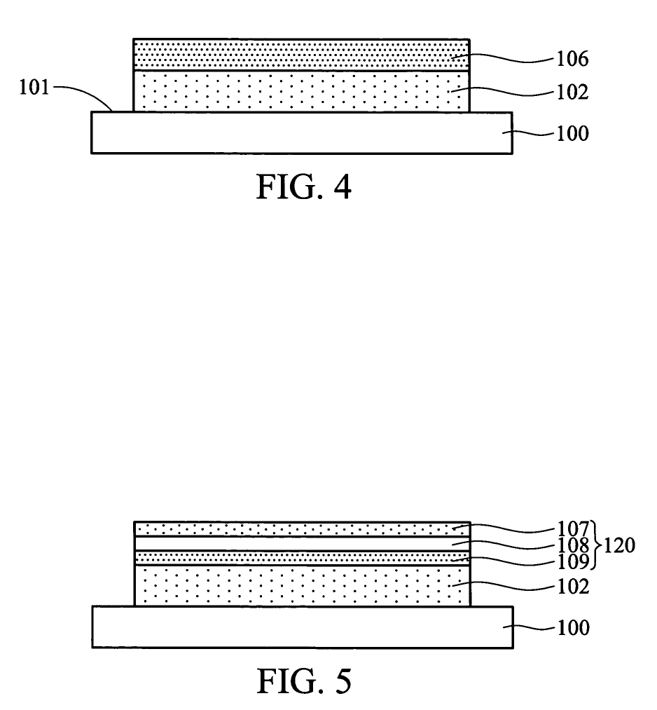

Referring to FIG. 4, an antireflective layer 106 with a thickness of 100 nm was further formed on the infrared cut-off hard coating 102 provided by Example 3. The antireflective layer 106 was formed by coating a composition comprising 0.3 g acrylic resin (sold and manufactured under the trade number of SR-399 by Sratomer Co., Ltd), 0.7 g Poly-1,1,1,3,3,3-hexafluoroisopropyl acrylate (antireflective dye), 0.03 g CIBA-184, and 19 g ethyl acetate.

Afterward, the transmittance of the layered composite film was measured at a measured wavelength between 400˜1900nm. The layered composite film had a transmittance of 84.33% at a measured wavelength of 550 nm and a transmittance of 12.91% at a measured wavelength of 1900 nm. The layered composite film had an infrared absorptivity of 87.09% at a measured wavelength of 1900 nm. Further, the layered composite film had a reflectivity of 2.07% at a measured wavelength of 550 nm.

### SIXTH EXAMPLE

Referring to FIG. 5, a layered antireflective layer 120 was formed on the infrared cut-off hard coating 102 provided by Example 3. The layered antireflective layer 120 comprises three antireflective layers 107, 108, and 109, and the refractive indexes of the three antireflective layers 107, 108, and 109 are respectively 1.44 (with a thickness of 85 nm), 1.91 (with a thickness of 107 nm), and 1.63 (with a thickness of 67 nm).

Afterward, the transmittance of the layered composite film was measured at a measured wavelength between 400˜1900 nm. The layered composite film had a transmittance of 87.6% at a measured wavelength of 550 nm and a transmittance of 14.51% at a measured wavelength of 1900 nm. The layered composite film had an infrared absorptivity of 85.49% at a measured wavelength of 1900 nm. Further, the layered composite film had a reflectivity of 0.51% at a measured wavelength of 550 nm.

### SEVENTH EXAMPLE

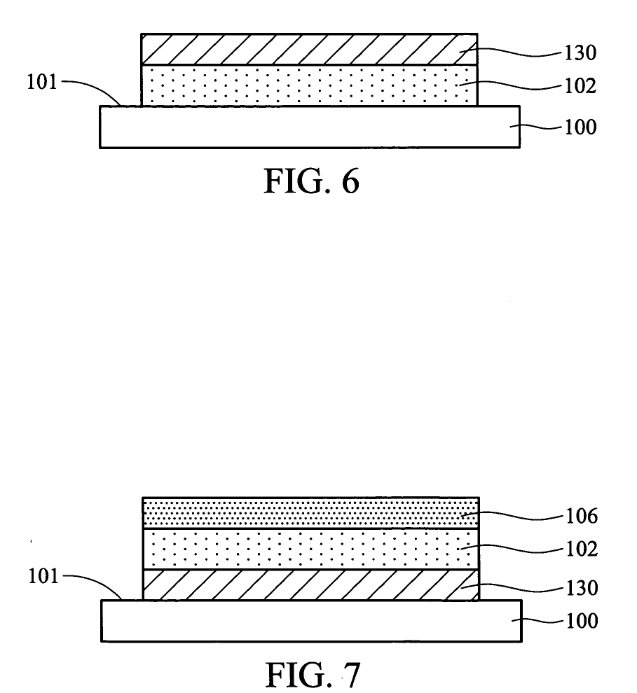

Referring to FIG. 6, an anti-glare layer 130 was formed on the infrared cut-off hard coating 102 provided by Example 3. The anti-glare layer 130 was formed by coating a composition comprising 3.8 g acrylic resin (sold and manufactured under the trade number of SR-399 by Sratomer Co., Ltd), 0.2g Soken SX-5004 (anti-glare platicles), 0.19g CIBA-184, and 1 ethyl acetate.

Afterward, the transmittance of the layered composite film was measured at a measured wavelength between 400˜1900 nm. The layered composite film had a transmittance of 81.24% at a measured wavelength of 550 nm and a transmittance of 12.30% at a measured wavelength of 1900 nm. The layered composite film had an infrared absorptivity of 87.79% at a measured wavelength of 1900 nm. Further, the layered composite film had a reflectivity of 1.52% at a measured wavelength of 550 nm.

### EIGHTH EXAMPLE

Referring to FIG. 7, an anti-glare layer 130 was formed on a surface 101 of a PET substrate 100. The anti-glare layer 130 was formed by coating a composition comprising 3.8 g acrylic resin (sold and manufactured under the trade number of SR-399 by Sratomer Co., Ltd), 0.2 g Soken SX-5004 (anti-glare platicles), 0.19 g CIBA-184, and 1ethyl acetate.

Next, the infrared cut-off composition (A) provided by Example 1 was coated on the anti-glare layer 130 to form an infrared cut-off hard coating 102 with a thickness of 5000 nm.

Next, an antireflective layer 106 with a thickness of 100 nm was further formed on the infrared cut-off hard coating 102. The antireflective layer 106 was formed by coating a composition comprising 6 g acrylic resin (sold and manufactured under the trade number of SR-399 by Sratomer Co., Ltd), 14g Poly-1,1,1,3,3,3-hexafluoroisopropyl acrylate (antireflective dye), 0.3 g CIBA-184, and ethyl acetate.

Afterward, the transmittance of the layered composite film was measured at a measured wavelength between 400˜1900 nm. The layered composite film had a transmittance of 81.59% at a measured wavelength of 550 nm and a transmittance of 10.71% at a measured wavelength of 1900 nm. The layered composite film had an infrared absorptivity of 89.29% at a measured wavelength of 1900 nm. Further; the layered composite film had a reflectivity of 1.50% at a measured wavelength of 550 nm.

The measured transmittance, reflectivity and infrared absorptivity of the layered composite film according to Examples 3˜8 are shown in Table 1.

TABLE 1

| | transmit- | | transmit- | |
|---|---|---|---|---|
| Exam- | tance % | reflectivity % | tance % | absorptivity % |
| ple | (550 nm) | (550 nm) | (1900 nm) | (1900 nm) |
| 3 | 82.55 | 8.9 | 14.27 | 85.73 |
| 4 | 81.80 | 1.53 | 11.93 | 88.07 |
| 5 | 84.33 | 2.07 | 12.91 | 87.09 |
| 6 | 87.6 | 0.51 | 14.51 | 85.49 |
| 7 | 81.24 | 1.52 | 12.30 | 87.70 |
| 8 | 81.59 | 1.50 | 10.71 | 89.29 |

As described in Table 1, the layered composite films comprising the infrared cut-off hard coating of the invention have high transmittance and low reflectivity for visible light and superior infrared absorptivity. Further, the infrared cut-off hard coating has high scratch resistance and mechanical strength due to the thickness of more than 1000 nm.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An infrared cut-off hard coating, comprising the product through the following steps:
(a) forming a coating of a composition, wherein the composition comprising the following components as a uniform solution in an organic solvent:
a multi-functionality polymerizable resin;
infrared cut-off particles; and
a free radical initiator, wherein the weight ratio between the particles and resin is 10:90 to 55:45;
(b) curing the coating to form the infrared cut-off hard coating with a thickness of not less than 1000 nm.

2. The infrared cut-off hard coating as claimed in claim 1, wherein the multi-functionality polymerizable resin comprises acrylic resin with multi-functionality or epoxy resin with multi-functionality.

3. The infrared cut-off hard coating as claimed in claim 1, wherein the free radical initiator comprises peroxide initiator or azo initiator.

4. The infrared cut-off hard coating as claimed in claim 1, wherein the infrared cut-off particles comprise ITO particles, IZO particles, AZO particles, ZnO particles, or combinations thereof.

5. The infrared cut-off hard coating as claimed in claim 1, wherein the thickness of the infrared cut-off hard coating is 1000 nm˜20000 nm.

6. The infrared cut-off hard coating as claimed in claim 1, wherein the refractive index of the infrared cut-off hard coating is 1.52˜1.80.

7. The infrared cut-off hard coating as claimed in claim 1, wherein the composition further comprises anti-glare particles, and the weight ratio between the anti-glare particles and the resin is 1:99 to 35:65.

8. An infrared cut-off hard coating, comprising the product through the following steps:
(a) forming a coating of a composition, wherein the composition comprising the following components as a uniform solution in an organic solvent:
a multi-functionality polymerizable resin;
anti-glare particles;
infrared cut-off particles; and
a free radical initiator, wherein the weight ratio between the particles and resin is 10:90 to 55:45, and the weight ratio between the anti-glare particles and the resin is 1:99 to 35:65;
(b) curing the coating to form the infrared cut-off hard coating with a thickness of not less than 1000 nm.

9. The infrared cut-off hard coating as claimed in claim 8, wherein the multi-functionality polymerizable resin comprises acrylic resin with multi-functionality or epoxy resin with multi-functionality.

10. The infrared cut-off hard coating as claimed in claim 8, wherein the free radical initiator comprises peroxide initiator or azo initiator.

11. The infrared cut-off hard coating as claimed in claim 8, wherein the infrared cut-off particles comprise ITO particles, IZO particles, AZO particles, ZnO particles, or combinations thereof.

12. The infrared cut-off hard coating as claimed in claim 8, wherein the thickness of the infrared cut-off hard coating is 1000 nm˜20000 nm.

13. The infrared cut-off hard coating as claimed in claim 8, wherein the refractive index of the infrared cut-off hard coating is 1.52˜1.80.

14. The infrared cut-off hard coating as claimed in claim 8, wherein the anti-glare particles, having a diameter of 100˜5000 nm, comprise organic polymeric or inorganic particles.

15. A method for fabricating infrared cut-off hard coating, comprising:
providing a composition comprising multi-functionality polymerizable resin, infrared cut-off particles, and a radical initiator, as a uniform solution in an organic solvent, wherein the weight ratio between the particles and resin is 10:90 to 55:45;
forming a coating of the composition; and
curing the coating to form the infrared cut-off hard coating with a thickness of not less than 1000 nm.

16. The method as claimed in claim 15, wherein the coating of the composition is formed by spin coating, dip coating, roll coating, printing, embossing, stamping, or spray coating.

17. The method as claimed in claim 15, wherein the coating is cured by exposing to an uniform ultraviolet with a wavelength more than 193 nm.

18. The method as claimed in claim 15, wherein the composition further comprises anti-glare particles, and the t weight ratio between the anti-glare particles and the resin is 1:99 to 35:65.

19. A layered composite film, comprising:
a transparent substrate, with a first surface and a second surface on the opposite side of the first surface; and
the infrared cut-off hard coating as claimed in claim 1 formed on the first surface.

20. The film as claimed in claim 19, wherein the substrate is plastic substrate.

21. The film as claimed in claim 19, further comprising an anti-glare film formed on the infrared cut-off hard coating.

22. The film as claimed in claim 19, further comprising an anti-glare film formed on the second surface.

23. The film as claimed in claim 19, further comprising an antireflective layer, having, a refractive index of 1.2˜1.48, formed on the infrared cut-off hard coating.
